(19) United States
(12) Patent Application Publication
(10) Pub. No.: US 2019/0232441 A1
(43) Pub. Date: Aug. 1, 2019

(54) CNC TURNING AND MILLING MACHINE

(71) Applicant: CHU-NENG YU, Taichung City (TW)

(72) Inventor: CHU-NENG YU, Taichung City (TW)

(21) Appl. No.: 16/056,533

(22) Filed: Aug. 7, 2018

(30) Foreign Application Priority Data
Jan. 29, 2018 (TW) 107201376

(51) Int. Cl. B23P 23/02; B23Q 39/02; B23C 7/02

(52) U.S. Cl. CPC B23P 23/02; B23Q 2039/004; B23C 7/02; B23Q 39/02

(57) ABSTRACT

A CNC turning and milling machine includes: a base, a moving unit, a spindle unit and a turret unit. The spindle limiting unit and the turret limiting unit are employed to limit the movement range, and the spindle unit and the turret unit are fixed on the upright post to strengthen the overall structural strength and reduce vibration during processing, thereby improving machining accuracy and processing efficiency, while reducing surface roughness.

### BACKGROUND

### Field of the Invention

The present invention relates to a compound processing machine, and more particularly to a CNC turning and milling machine.

### Related Prior Art

Please refer to FIG. 1 for a perspective view of a conventional CNC turning and milling machine, and the combination of a general turning machine and milling machine has been widely used in various factories. However, since the turret 1 of the turning machine of the above structure is connected to the mounting seat 2, when the turning tool 3 of the turning machine is machining the workpiece, since the turret 1 is away from the mounting seat 2, the joint portion between the two members may be damaged due to vibration and insufficient rigidity, so there is a possibility of cracking.

In addition, when the turret 1 and the mounting seat 2 are damaged, it is likely to produce the problems such as angle change, feed distortion and rigidity weakening and so on, and then cause the dimension error in processing the workpiece, which leads to poor precision, poor processing surface and poor processing efficiency.

The present invention has arisen to mitigate and/or obviate the afore-described disadvantages.

### SUMMARY

One objective of the present invention is to provide a CNC turning and milling machine capable of strengthening the overall structural strength and reducing vibration during processing, thereby improving machining accuracy and processing efficiency, while reducing surface roughness.

To achieve the above objective, a CNC turning and milling machine for milling and turning a workpiece in accordance with the present invention comprises:

a base including a clamping direction for clamping the workpiece, a displacement direction perpendicular to the clamping direction, and a milling direction perpendicular to the clamping direction and the displacement direction;

a moving unit including: a moving module disposed on the base and reciprocally movable along the clamping direction, and an upright post disposed on the moving module and reciprocally movable toward the workpiece along the displacement direction, wherein the upright post includes a first displacement portion and a second displacement portion;

a spindle unit including a milling tool module that is disposed on the first displacement portion and reciprocally movable toward the workpiece along the milling direction; and

a turret unit including a turning tool module that is disposed on the second displacement portion and reciprocally movable toward the workpiece along the milling direction.

Preferably, the CNC turning and milling machine further includes a spindle limiting unit, wherein the spindle limiting unit is disposed at the first displacement portion, and includes: a first spindle limiting portion disposed at one end of the first displacement portion, a second spindle limiting portion disposed at another end of the first displacement portion, and a restricting rod connected between the first spindle limiting portion and the second spindle limiting portion, and the spindle unit is disposed between the first spindle limiting portion and the second spindle limiting portion.

Preferably, the CNC turning and milling machine further includes a turret limiting unit, wherein the turret limiting unit is disposed at the second displacement portion, and includes: a first turret limiting portion disposed at one end of the second displacement portion, a second turret limiting portion disposed at another end of the second displacement portion, and a position limiting bar connected between the first turret limiting portion and the second turret limiting portion, and the turret unit is disposed between the first turret limiting portion and the second turret limiting portion.

Preferably, the CNC turning and milling machine further includes a clamping unit which is disposed on the base at a distance from the moving unit and has a tailstock module capable of locking the workpiece.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a perspective view of a conventional CNC machine;

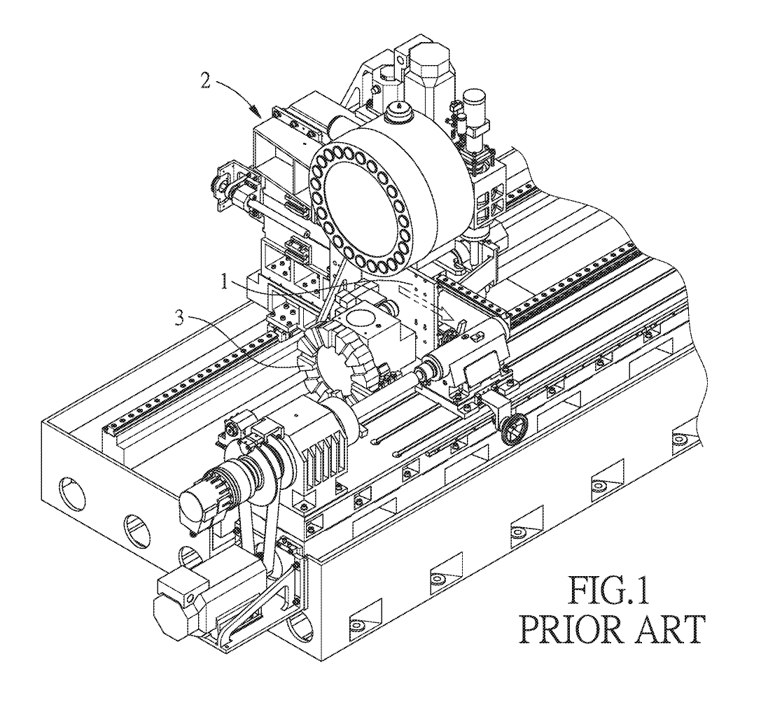

FIG. 2 is a perspective view of the CNC turning and milling machine in accordance with the preferred embodiment of the invention;

FIG. 3 is a perspective view of a part of the CNC turning and milling machine in accordance with the preferred embodiment of the invention;

FIG. 4 is an exploded view of FIG. 3;

FIG. 5 is an illustrative view of the CNC turning and milling machine in accordance with the preferred embodiment of the invention;

FIG. 6 is another illustrative view of the CNC turning and milling machine in accordance with the preferred embodiment of the invention; and

FIG. 7 is another illustrative view of the CNC turning and milling machine in accordance with the preferred embodiment of the invention.

### DETAILED DESCRIPTION

The present invention will be clearer from the following description when viewed together with the accompanying drawings, which show, for purpose of illustrations only, the preferred embodiment in accordance with the present invention.

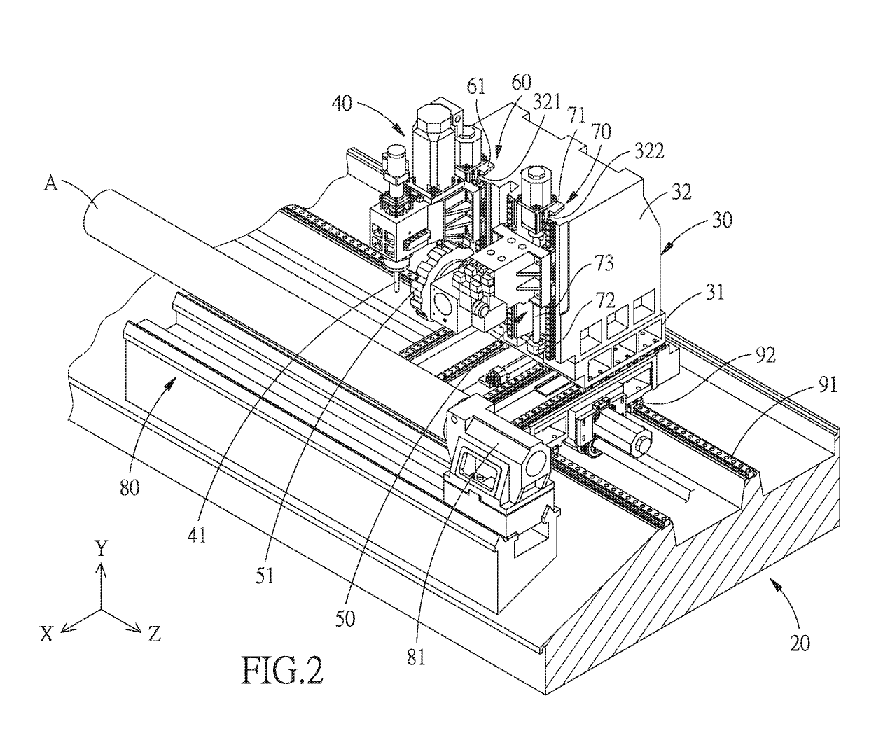

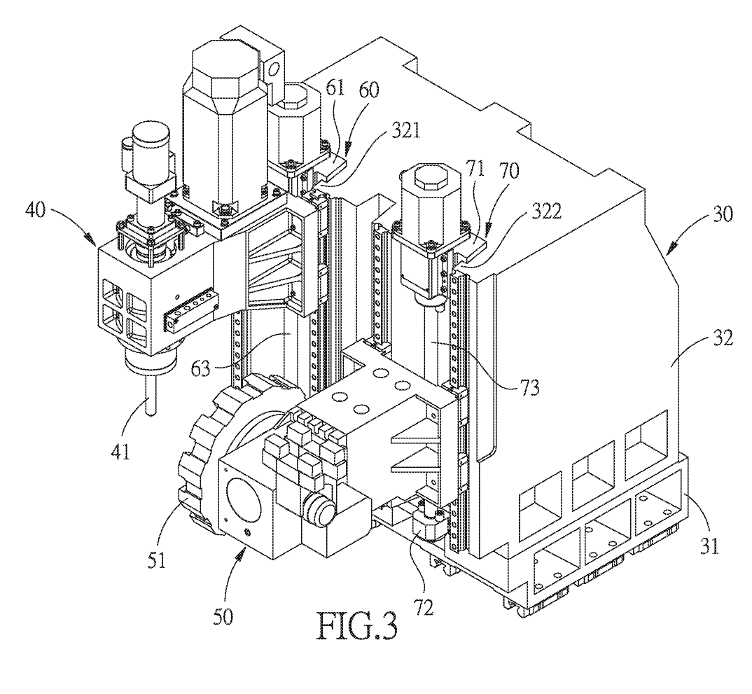

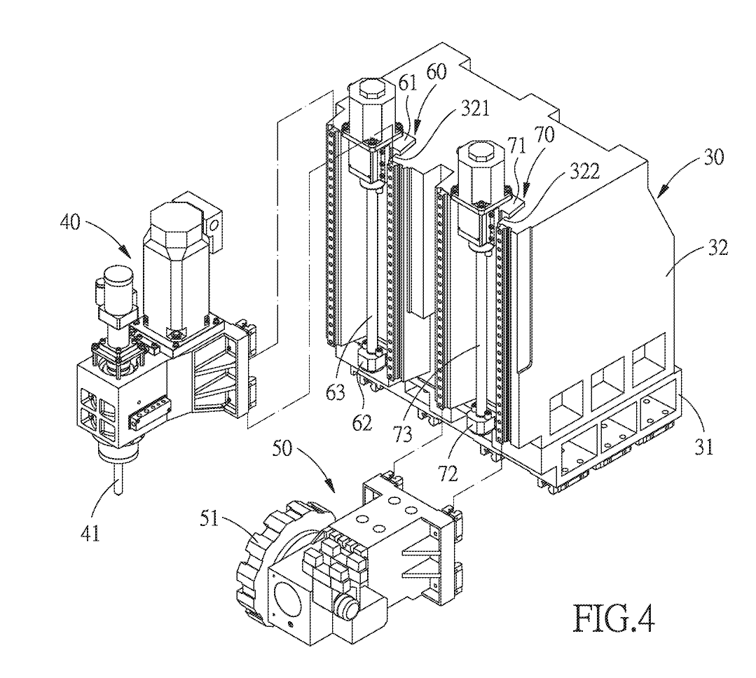

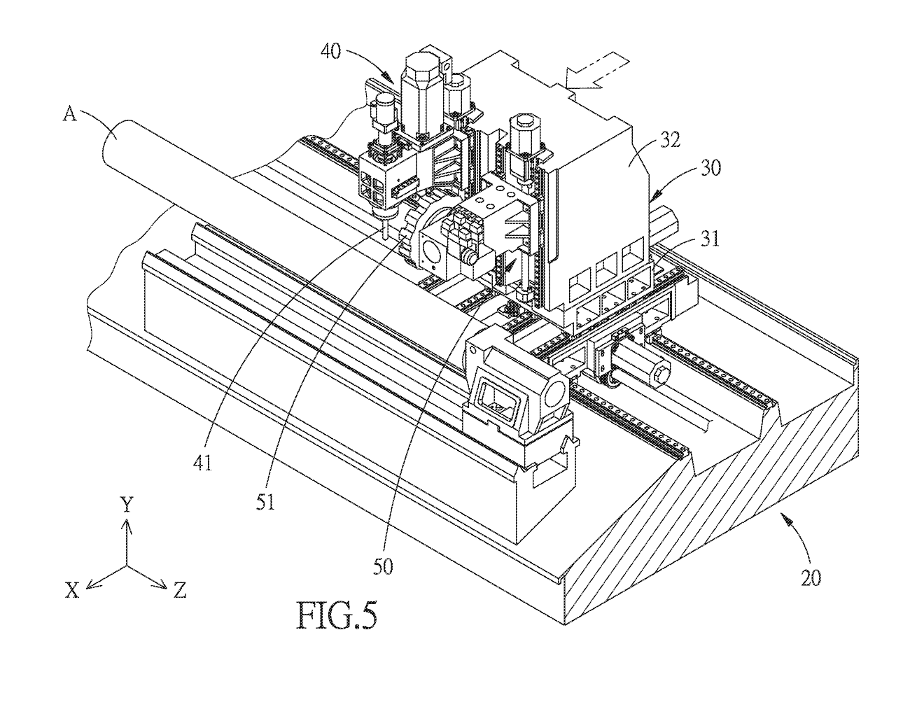

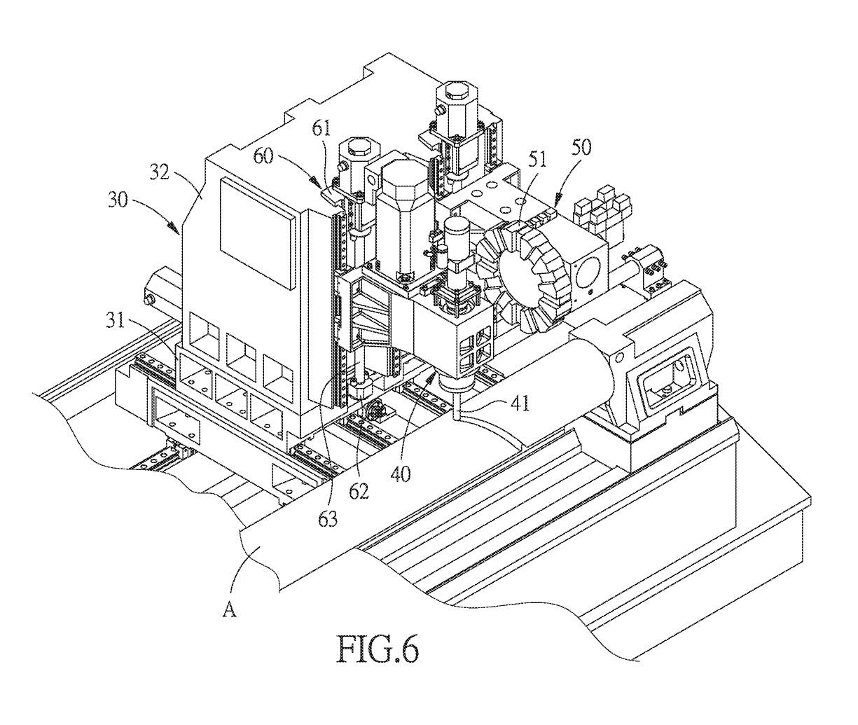

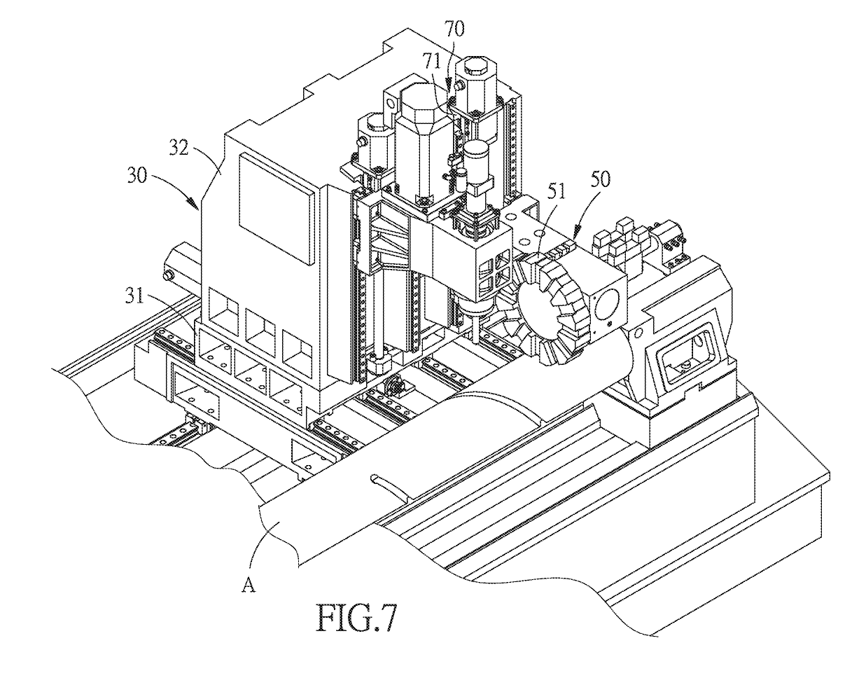

Referring to FIGS. 2-7, a CNC turning and milling machine in accordance with the preferred embodiment of the invention for milling and turning a workpiece A comprises: a base 20, a moving unit 30, a spindle unit 40 and a turret unit 50.

The base 20 includes a clamping direction Z for clamping the workpiece A, a displacement direction X perpendicular to the clamping direction Z, and a milling direction Y perpendicular to the clamping direction Z and the displacement direction X.

The moving unit 30 includes: a moving module 31 that is reciprocally movable along the clamping direction Z and disposed on the base 20, and an upright post 32 that is disposed on the moving module 31 and reciprocally movable toward the workpiece A along the displacement direction X. The upright post 32 of the moving module 31 is provided with a first displacement portion 321 and a second displacement portion 322.

The spindle unit 40 includes a milling tool module 41 that is disposed on the first displacement portion 321 and reciprocally movable toward the workpiece A along the milling direction Y.

The turret unit 50 includes a turning tool module 51 that is disposed on the second displacement portion 322 and reciprocally movable toward the workpiece A along the milling direction Y.

Preferably, the CNC turning and milling machine in accordance with the invention further includes: a spindle limiting unit 60 and a turret limiting unit 70. The spindle limiting unit 60 is disposed at the first displacement portion 321, and includes: a first spindle limiting portion 61 disposed at one end of the first displacement portion 321, a second spindle limiting portion 62 disposed at another end of the first displacement portion 321, and a restricting rod 63 connected between the first spindle limiting portion 61 and the second spindle limiting portion 62. The spindle unit 40 is disposed between the first spindle limiting portion 61 and the second spindle limiting portion 62. The turret limiting unit 70 is disposed at the second displacement portion 322, and includes: a first turret limiting portion 71 disposed at one end of the second displacement portion 322, a second turret limiting portion 72 disposed at another end of the second displacement portion 322, and a position limiting bar 73 connected between the first turret limiting portion 71 and the second turret limiting portion 72. The turret unit 50 is disposed between the first turret limiting portion 71 and the second turret limiting portion 72. By such arrangements, the slide range of the spindle unit 40 and the turret unit 50 is limited, and the upright post 32 secures the connection point between the spindle unit 40 and the turret unit 50, and it is less likely to cause insufficient support to the connection point during movement.

Preferably, the CNC turning and milling machine in accordance with the invention further includes a clamping unit 80 which is disposed on the base 20 at a distance from the moving unit 30 and has a tailstock module 81 capable of locking the workpiece A.

Preferably, the CNC turning and milling machine in accordance with the invention further includes: a slide rail assembly 90 which includes two slide rails 91 and a plurality of sliders 92. The two slide rails 91 are fixed to the base 20 in a parallel manner along the clamping direction Z. The sliders 92 are movably disposed on the two slide rails 91 and provided for mounting of the moving module 31.

In summary, the present invention limits the movement range through the spindle limiting unit 60 and the turret limiting unit 70, and the spindle unit 40 and the turret unit 50 are fixed on the upright post 32 to strengthen the overall structural strength and reduce vibration during processing, thereby improving machining accuracy and processing efficiency, while reducing surface roughness.

While we have shown and described various embodiments in accordance with the present invention, it is clear to those skilled in the art that further embodiments may be made without departing from the scope of the present invention.

What is claimed is:

1. A CNC turning and milling machine for milling and turning a workpiece, comprising:
a base including a clamping direction for clamping the workpiece, a displacement direction perpendicular to the clamping direction, and a milling direction perpendicular to the clamping direction and the displacement direction;
a moving unit including: a moving module disposed on the base and reciprocally movable along the clamping direction, and an upright post disposed on the moving module and reciprocally movable toward the workpiece along the displacement direction, wherein the upright post includes a first displacement portion and a second displacement portion;
a spindle unit including a milling tool module that is disposed on the first displacement portion and reciprocally movable toward the workpiece along the milling direction; and
a turret unit including a turning tool module that is disposed on the second displacement portion and reciprocally movable toward the workpiece along the milling direction.

2. The CNC turning and milling machine as claimed in claim 1 further comprising a spindle limiting unit, wherein the spindle limiting unit is disposed at the first displacement portion, and includes: a first spindle limiting portion disposed at one end of the first displacement portion, a second spindle limiting portion disposed at another end of the first displacement portion, and a restricting rod connected between the first spindle limiting portion and the second spindle limiting portion, and the spindle unit is disposed between the first spindle limiting portion and the second spindle limiting portion.

3. The CNC turning and milling machine as claimed in claim 1 further comprising a turret limiting unit, wherein the turret limiting unit is disposed at the second displacement portion, and includes: a first turret limiting portion disposed at one end of the second displacement portion, a second turret limiting portion disposed at another end of the second displacement portion, and a position limiting bar connected between the first turret limiting portion and the second turret limiting portion, and the turret unit is disposed between the first turret limiting portion and the second turret limiting portion.

4. The CNC turning and milling machine as claimed in claim 1 further comprising a clamping unit which is disposed on the base at a distance from the moving unit and has a tailstock module capable of locking the workpiece.
